(19) United States
(12) Patent Application Publication
(10) Pub. No.: US 2014/0043188 A1
(43) Pub. Date: Feb. 13, 2014

(54) GLOBAL POSITIONING SYSTEM RADIOMETRIC EVALUATION

(71) Applicant: CALIFORNIA INSTITUTE OF TECHNOLOGY, Pasadena, CA (US)

(72) Inventors: Shailen D. DESAI, Altadena, CA (US); Bruce J. HAINES, South Pasadena, CA (US)

(73) Assignee: CALIFORNIA INSTITUTE OF TECHNOLOGY, Pasadena, CA (US)

(21) Appl. No.: 13/951,902

(22) Filed: Jul. 26, 2013

Related U.S. Application Data
(60) Provisional application No. 61/681,458, filed on Aug. 9, 2012.

(51) Int. Cl. G01S 19/20

(52) U.S. Cl. CPC G01S 19/20
USPC 342/357.58

(57) ABSTRACT

Methods and devices for the analysis of global positioning system (GPS) data are described. The methods and devices comprise several metrics to analyse GPS data, such as tracking coverage, signal to noise ratio, multipath noise, positioning and receiver clock, troposphere and data noise.

### CROSS REFERENCE TO RELATED APPLICATIONS

The present application claims priority to U.S. Provisional Patent Application No. 61/681,458 filed on Aug. 9, 2012, and may be related to U.S. Pat. No. 5,963,167 filed Mar. 13, 1997 and U.S. Pat. No. 6,295,021 filed Aug. 18, 1999, the disclosure of all of which is incorporated herein by reference in their entirety.

### STATEMENT OF GOVERNMENT GRANT

The invention described herein was made in the performance of work under a NASA contract, and is subject to the provisions of Public Law 96-517 (35 USC 202) in which the Contractor has elected to retain title.

### TECHNICAL FIELD

The present disclosure relates to radiometric signal engineering. More particularly, it relates to global positioning system radiometric evaluation.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates an example of the functioning of the GPS satellites and receivers.

FIG. 2 illustrates a flowchart to analyze GPS data.

FIG. 3 illustrates a flowchart for the evaluation of measurement quality.

FIG. 4 illustrates a flowchart for the evaluation of positioning quality.

FIG. 5 depicts a computer which can analyze GPS data.

### SUMMARY

According to a first aspect, a method for analyzing Global Positioning System (GPS) measurements is described, the method comprising: providing GPS receiver data from a GPS receiver; evaluating, by a computer, a measurement quality of the GPS receiver data, thereby obtaining measurement quality metrics; obtaining GPS metrics from the GPS receiver data; evaluating, by a computer, a positioning quality of the GPS receiver data, by analyzing the GPS metrics with a computer, thereby obtaining positioning quality metrics; and displaying to a user the measurement quality metrics and/or positioning quality metrics.

According to a second aspect, an electronic device for analyzing Global Positioning System (GPS) measurements is described, the device comprising: a GPS receiver, wherein the GPS receiver is configured to receive GPS data; a measurement quality component, configured to evaluate a measurement quality of the GPS data, thereby obtaining measurement quality metrics; a GPS metrics component, configured to produce GPS metrics from the GPS data; a positioning quality component, configured to evaluate a positioning quality of the GPS metrics and/or the GPS data, thereby obtaining positioning quality metrics; and a metrics display component, configured to display the measurement quality metrics and/or the positioning quality metrics.

### DESCRIPTION

In the present disclosure, by ‘metric’ a measurement or set of measurements (such as in a statistical sense) of a specific property is intended.

The Global Positioning System (GPS) is very useful for a variety of activities, from recreational to industrial, from economical to military. Evaluation of the accuracy of tracking measurements provided by GPS receivers is an important engineering challenge.

The Global Positioning System (GPS) Radiometric Evaluation Software (GPSRES) evaluates the quality of tracking measurements from GPS receivers, on satellites orbiting the Earth or on platforms on the surface of the Earth, as well as the quality of the positioning estimates computed from those measurements.

The United States GPS constellation is composed of 24-30 satellites that are continuously transmitting signals towards the Earth from an altitude of 20000 kilometers. Using the GPS signals, receivers at stations on or near the surface of the Earth—or in low orbits around the Earth—determine the distance between the transmitting and receiving platforms. From these tracking measurements, the position and time of the receiving platform can be computed, in effect using trilateration, but employing range measurements to all GPS satellites in its view (typically 6-12). Trilateration is the determination of absolute or relative locations of points by measurement of distances, using the geometry of circles, spheres or triangles.

The accuracy of the computed positions of the receiving platform depends in large measure on the quality of the GPS receiver and its measurements. The highest-quality receivers can achieve accuracies of better than 1 centimeter. Higher quality GPS receivers can use techniques to improve their accuracy, for example, among others, differential GPS (DGPS) and Wide Area Augmentation System (WAAS).

The method implemented through computers running the Global Positioning System (GPS) Radiometric Evaluation Software (GPSRES) has proven useful throughout the development lifecycle of high-quality GPS receivers to: evaluate overall measurement and positioning performance; identify measurement anomalies originating with receiver hardware or firmware; and manage data to automatically compute the platform positions using the GIPSY/OASIS software from the Jet Propulsion Laboratory. GIPSY/OASIS stands for GNSS Inferred Positioning System and Orbit Analysis Simulation Software, where GNSS stands for Global Navigation Satellite System. GIPSY/OASIS is described, for example, in U.S. Pat. No. 5,963,167 and U.S. Pat. No. 6,295,021, the disclosure of both being included herein by reference in their entirety.

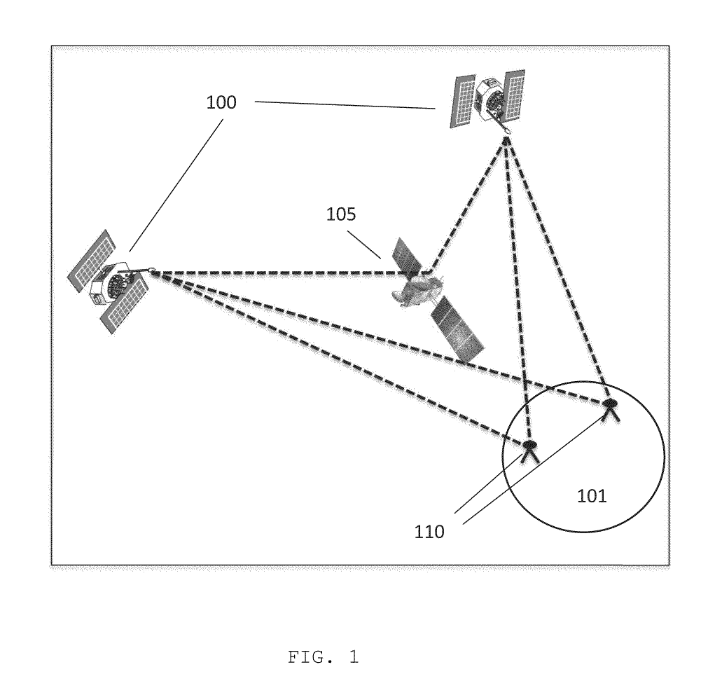

FIG. 1 illustrates an example of the functioning of the GPS satellites and receivers. The GPS constellation of satellites (100) transmits signals towards Earth (101), which are received by GPS receivers, for example on board Earth-orbiting satellites (105) or ground stations (110).

Data files containing the tracking measurements from a GPS receiver, placed anywhere with a good sky view on or near the Earth's surface, are made available to GPSRES. In one embodiment of the disclosure, these data files are managed by GPSRES to evaluate overall receiver performance in two stages:
a. GPSRES evaluates measurement quality directly from the content of the data files, to be provided in formats recognized by GPSRES. The results of this step are used to develop an assessment known as the receiver's “radiometric performance”.
b. GPSRES automatically passes the data files, in Receiver Independent Exchange (RINEX) format, to JPL's GIPSY/OASIS software to perform precise positioning of the platform (ground or space) that hosts the GPS receiver. GPSRES then performs automated evaluations of the overall positioning quality from the GIPSY/OASIS output. These output products include a range of GPS metrics such as: the position of the platform hosting the GPS receiver, expressed in the international terrestrial reference frame; the receiver's clock offset with respect to Universal Coordinated Time; and the tropospheric conditions at the platform (where relevant). GIPSY/OASIS also reports that portion of the measurements that cannot be explained by the estimated positions, clock, and troposphere.

A range of quality metrics from both the radiometric (point a. above) and positioning (point b. above) evaluations can be computed, tabulated and visually represented by GPSRES. Those results can then be provided to the user via e-mail and through automatically generated web sites that are viewed using an internet browser.

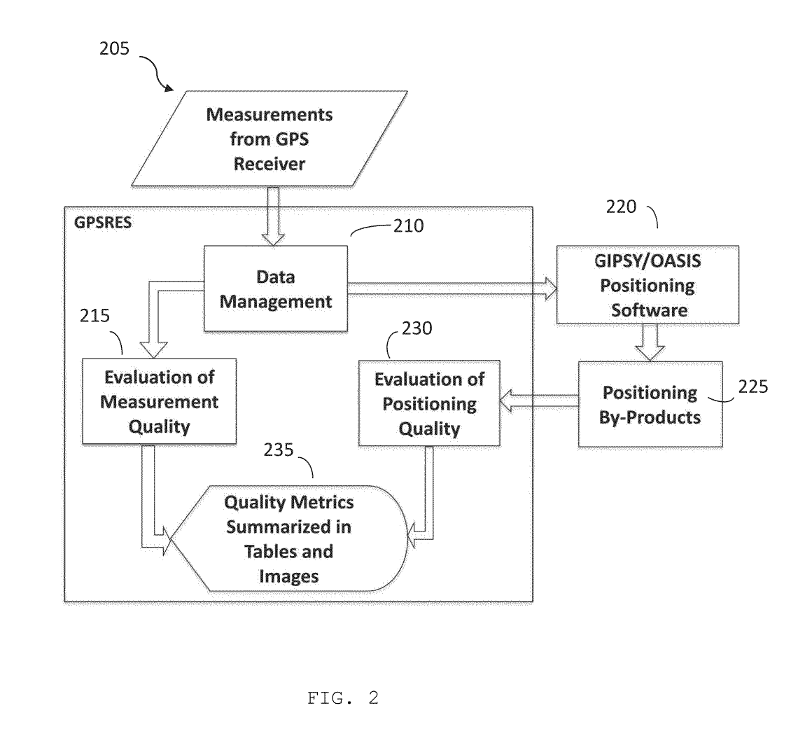

FIG. 2 illustrates the steps of one embodiment of the method described above. Measurement data (205) are received by a GPS receiver. A data management device (210) processes the data so that it is evaluated in two different ways: one step (215) consists in evaluating the quality of the measurement, assessing the radiometric performance of the GPS receiver; a second way (220) consists in determining the precise position of the GPS receiver using GIPSY/OASIS. Step (220) produces several products (225), or GPS metrics, such as the position of the platform hosting the GPS receiver and the receiver's clock offset with respect to Universal Coordinated Time. These GPS metrics (225) of step (220) are evaluated in step (230) to determine the quality of the positioning measurements of the GPS receiver. In step (235) both evaluations from modules (215) and (230), are summarized, and their quality metrics are displayed in different forms, such as with tables and images.

In one embodiment of the disclosure, the radiometric performance of a GPS receiver can be assessed using three groups of indicators, each represented by metrics that provide insights on the capability of the receiver to support accurate positioning:
1. Tracking Coverage
   a. Statistics and temporal variations in the number of satellites tracked at each measurement epoch.
   b. Statistics on length of continuous tracking measurements to each GPS satellite, and from all satellites.
   c. Gaps in tracking data.
2. Signal to Noise Ratio (SNR)
   a. Statistics and temporal variations of absolute measurement SNR at different GPS frequencies to each GPS satellite, and from all satellites.
   b. Statistics and temporal variations of relative measurement SNR at different GPS frequencies for each GPS satellite, and from all satellites.
3. Multipath
   a. Statistics of multipath data noise to each GPS satellites, and from all satellites, where multipath data noise reflects the impact of the local environment near the receiver.
   b. Systematic errors in measurements manifesting as spurious biases or drifts.

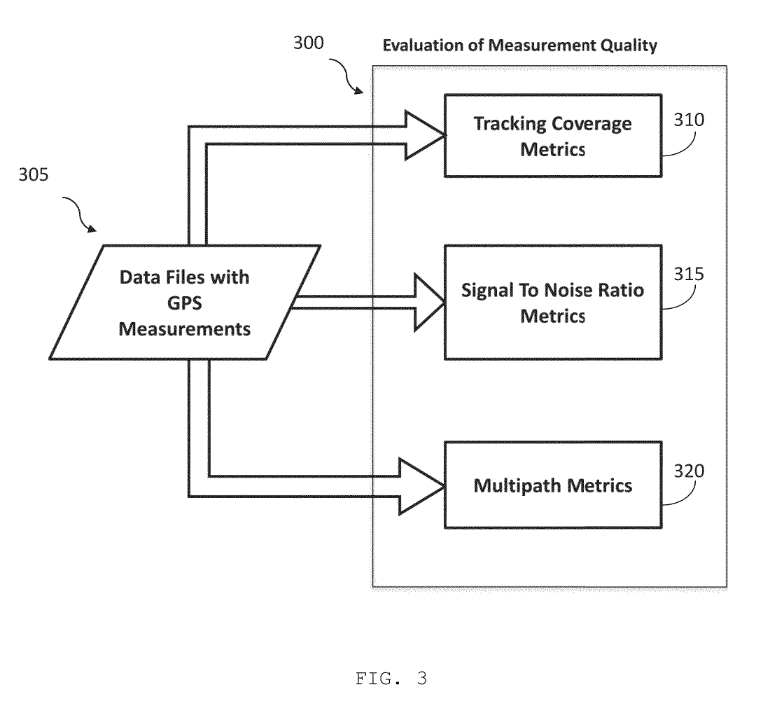

The evaluation of the quality of the measurements, or radiometric performance, corresponds to step (215) in FIG. 2. Referring to FIG. 3, the radiometric performance step (300) analyzes the GPS data (305). The analysis can be divided into three groups of metrics, corresponding to the list above: tracking coverage (310), signal to noise ratio (315) and multipath metrics (320).

Tracking coverage metrics (310) comprise metrics such as those relating to the number of satellites over time, which are visible from the GPS receiver and are being tracked by the GPS receiver. Other metrics comprise the degree of continuity in the tracking of each satellite, for example if a satellite is visible for a certain duration, then it becomes not visible and then visible again. For example, even in an unobstructed open-sky location GPS satellites will rise and set from the perspective of the receiver, the GPS receiver hardware may lose lock on GPS signals, or a building might obscure the signal from a GPS satellite. Therefore, the tracking coverage step will also keep tab of any gap in the coverage of GPS satellites.

Signal to noise ratio metrics (315) comprise metrics such as those relating to the signal to noise ratio of the GPS measurements received from the GPS satellites. Specifically, the signal to noise ratio can be analyzed at each of the different frequencies and pseudorandom ranging codes of the GPS signals. The signal to noise ratio step (315) can track both absolute and relative values.

Multipath metrics (320) comprise metrics such as those relating to multipath data noise. Multipath data noise arises from the known fact that radio waves can be received along a straight path from the transmitter to the receiver, but also along alternative path, e.g. bouncing off nearby surfaces. Any radio wave originating from the transmitter might be reflected and arrive at the receiver along a different path. Multiple radio waves arriving at the receiver might interfere, hence causing noise due to multipath reflections. The multipath metrics step (320) also analyzes other errors originating from bias or drift in the data.

The evaluation of the quality of the measurements, or radiometric performance, described above referring to FIG. 3, corresponds to step (215) in FIG. 2. Step (230) in FIG. 2 corresponds to the evaluation of the positioning quality.

The quality of the positioning capability of a GPS receiver is assessed using four groups of indicators, each encompassing a group of metrics. These metrics are based upon the GPS metrics (or products) generated by processing the GPS measurements in JPL's precise positioning software, GIPSY/OASIS. The four groups of indicators comprise:
1. Positioning Metrics
   a. Statistics on quality of platform positions and depictions of apparent temporal variations of the receiving platform position.
2. Receiver Clock Stability Metrics (Receiver clock is simultaneously determined with platform position).
   a. Statistics and depictions of temporal variations of the receiver clock.
3. Troposphere Metrics (Conditions of troposphere at the platform are simultaneously determined with platform position).
   a. Statistics and depictions of temporal variations of the troposphere at the platform.
4. Data Noise Metrics
   a. Statistics and depictions of temporal variations of the portion of measurements that are not explained by the position, receiver clock, and platform troposphere conditions, also referred to as post-fit residuals.
   b. Distribution of measurements by the elevation of the line-of-sight from the local horizon to the GPS satellites.

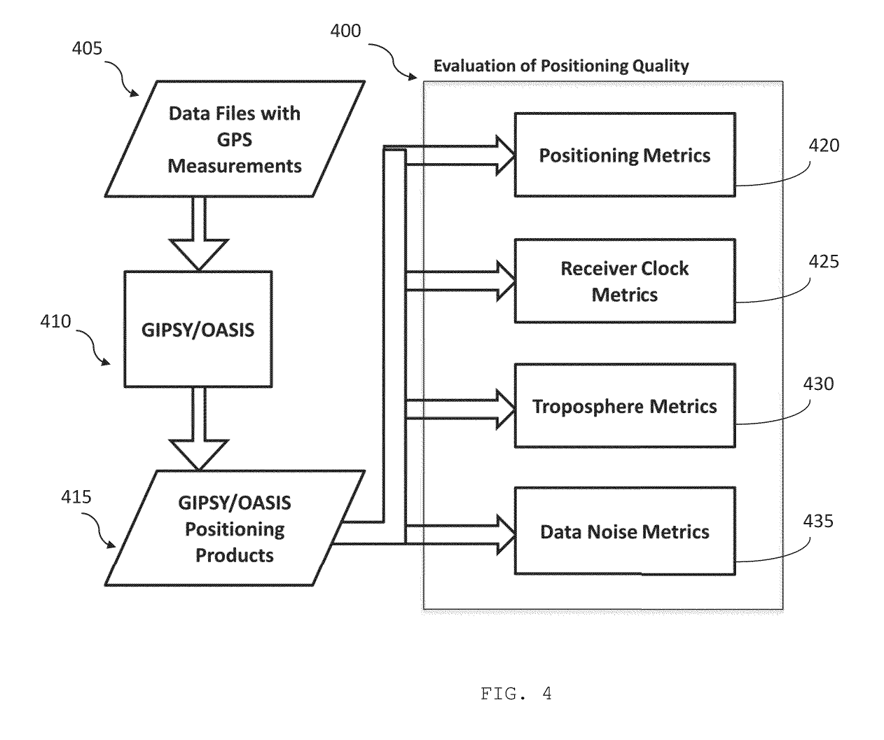

Step (230) in FIG. 2 corresponds to the evaluation of the positioning quality. Step (230) is described in more details in FIG. 4.

Referring to FIG. 4, the GPS data (405) is sent to the GIPSY/OASIS software (410), which outputs a number of GPS metrics or products (415). In other words, GPS metrics (415) are obtained from the GPS data (405). In one embodiment, in the positioning quality step (400) these GPS metrics or products are reviewed and analyzed. The analysis can be divided into four groups of metrics, corresponding to the list above: positioning (420), receiver clock stability (425), troposphere (430) and data noise metrics (435).

Positioning metrics (420) comprise metrics such as those relating to variations in the position over time of the GPS receiver's platform. Receiver clock stability metrics (425) comprise metrics such as those relating to the accuracy of temporal measurements of the receiver's clock.

Troposphere metrics (430) comprise metrics such as those relating to errors introduced by the troposphere. For example, generally the troposphere has a smaller effect on the quality of GPS signals when a GPS satellite is directly overhead a GPS receiver. As a satellite moves closer to the Earth's horizon, the GPS signals have to travel across a larger portion of the troposphere, hence becoming more susceptible to errors introduced by the physical effects of the troposphere on radio waves. The effect of the troposphere on the GNSS signals comprises an extra delay in the signal traveling from the GPS satellite to receiver. This delay depends on the temperature, pressure, and humidity, along the line-of-sight between the GPS receiver and transmitter.

Data noise metrics (435) comprise metrics such as those relating to any errors not identified as originating from other sources analyzed by other metrics modules. These errors are referred to as post-fit residuals. Other metrics analyzed in step (435) comprise the distribution of measurements by the elevation of the line-of-sight from the local horizon to the GPS satellites. For example, at higher elevations there is less delay in the GPS signal due to the shorter path of the signals going through the atmosphere.

The embodiments described above disclose both methods to carry out data analysis of GPS signals on a computer or electronics devices, as well as device modules that can be implemented either as software components in a computer or electronic device, or hardware modules which can constitute a hardware device to analyze GPS signals. In particular, the steps disclosed above could be implemented in a GPS receiver.

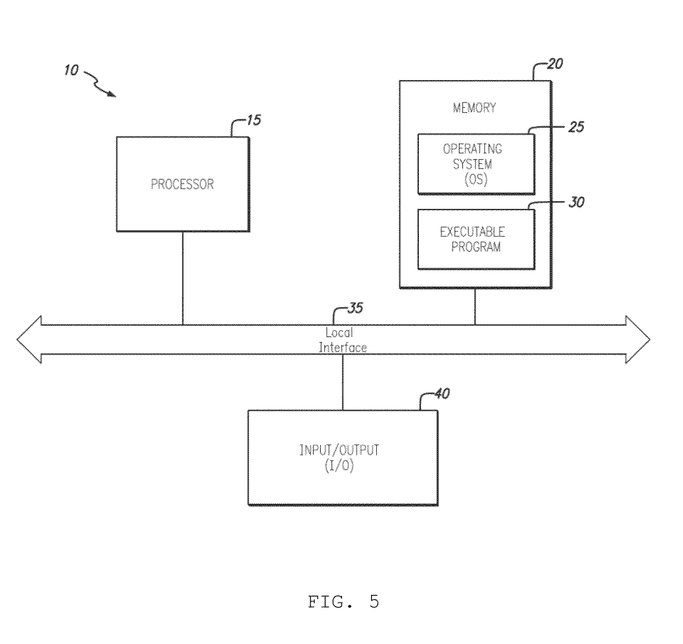

FIG. 5 is an exemplary embodiment of a target hardware (10) (e.g. a computer system) for implementing the embodiments of the present disclosure. Specifically, the target hardware of FIG. 5 could be present in a GPS receiver to carry out the steps of the methods of FIG. 2. This target hardware comprises a processor (15), a memory bank (20), a local interface bus (35) and one or more Input/Output devices (40). The processor may execute one or more instructions related to the implementation of FIGS. 3 and 4, and as provided by the Operating System (25) based on some executable program stored in the memory (20). These instructions are carried to the processors (20) via the local interface (35) and as dictated by some data interface protocol specific to the local interface and the processor (15). It should be noted that the local interface (35) is a symbolic representation of several elements such as controllers, buffers (caches), drivers, repeaters and receivers that are generally directed at providing address, control, and/or data connections between multiple elements of a processor based system. In some embodiments the processor (15) may be fitted with some local memory (cache) where it can store some of the instructions to be performed for some added execution speed. Execution of the instructions by the processor may require usage of some input/output device (40), such as inputting data from a file stored on a hard disk, inputting commands from a keyboard, outputting data to a display, or outputting data to a USB flash drive. In some embodiments, the operating system (25) facilitates these tasks by being the central element to gathering the various data and instructions required for the execution of the program and provide these to the microprocessor. In some embodiments the operating system may not exist, and all the tasks are under direct control of the processor (15), although the basic architecture of the target hardware device (10) will remain the same as depicted in FIG. 5. In some embodiments a plurality of processors may be used in a parallel configuration for added execution speed. In such a case, the executable program may be specifically tailored to a parallel execution. Also, in some embodiments the processor (15) may execute part of the implementation of the methods of the present disclosure, and some other part may be implemented using dedicated hardware/firmware placed at an Input/Output location accessible by the target hardware (10) via local interface (35). The target hardware (10) may include a plurality of executable program (30), wherein each may run independently or in combination with one another. Such executable program (30) may run on a GPS receiver.

The methods and systems described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The examples set forth above are provided to those of ordinary skill in the art a complete disclosure and description of how to make and use the embodiments of the gamut mapping of the disclosure, and are not intended to limit the scope of what the inventor/inventors regard as their disclosure.

Modifications of the above-described modes for carrying out the methods and systems herein disclosed are obvious to persons of skill in the art and are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A method for analyzing Global Positioning System (GPS) measurements, the method comprising:
providing GPS receiver data from a GPS receiver;
evaluating, by a computer, a measurement quality of the GPS receiver data, thereby obtaining measurement quality metrics;
obtaining GPS metrics from the GPS receiver data;
evaluating, by a computer, a positioning quality of the GPS receiver data, by analyzing the GPS metrics with a computer, thereby obtaining positioning quality metrics; and
displaying to a user the measurement quality metrics and/or positioning quality metrics.

2. The method of claim 1, wherein the evaluating, by a computer, the measurement quality comprises steps taken from the group of: counting a number of satellites tracked by a GPS receiver, measuring a length of continuous tracking of the satellites, measuring gaps in the tracking of the satellites, measuring absolute and/or relative temporal variations in signal to noise ratio of the GPS receiver data, determining multipath noise in the GPS receiver data, determining systematic errors, biases and/or drifts in the GPS receiver data.

3. The method of claim 1, wherein the evaluating, by a computer, the positioning quality comprises steps taken from the group of: measuring temporal variations in a position of a GPS receiver, measuring variations in a clock of the GPS receiver, measuring variations in troposphere relevant for reception of the GPS receiver data, measuring post-fit residuals, determining a distribution of measurements by an elevation of line-of-sight from a local horizon to GPS satellites.

4. An electronic device for analyzing Global Positioning System (GPS) measurements, the device comprising:
a GPS receiver, wherein the GPS receiver is configured to receive GPS data;
a measurement quality component, configured to evaluate, by the GPS receiver, a measurement quality of the GPS data, thereby obtaining measurement quality metrics;
a GPS metrics component, configured to produce, by the GPS receiver, GPS metrics from the GPS data;
a positioning quality component, configured to evaluate, by the GPS receiver, a positioning quality of the GPS metrics and/or the GPS data, thereby obtaining positioning quality metrics; and
a metrics display component, configured to display, by the GPS receiver, the measurement quality metrics and/or the positioning quality metrics.

5. The device of claim 4, wherein the measurement quality module comprises:
a tracking coverage component, configured to determine tracking coverage metrics;
a signal to noise ratio component, configured to determine signal to noise ratio metrics; and
a multipath component, configured to determine multipath metrics.

6. The device of claim 4, wherein the positioning quality module comprises:
a positioning component, configured to determine positioning metrics;
a receiver clock component, configured to determine receiver clock metrics;
a troposphere component, configured to determine troposphere metrics; and
a data noise component, configured to determine data noise metrics.

7. A system for analyzing Global Positioning System (GPS) measurements, the system comprising:
the electronic device of claim 4; and
a constellation of GPS satellites, wherein the GPS satellites are configured to transmit the GPS data.
